(19) United States
(12) Patent Application Publication
(10) Pub. No.: US 2026/0288470 A1
(43) Pub. Date: Sep. 24, 2026

(54) System, Method, and Computer Program Product for Processing Inference Requests to Execute a Machine-Learning Model

(71) Applicant: Visa International Service Association, San Francisco, CA (US)

(72) Inventors: Xuyang Xiao, Austin, TX (US); Ningyu Shi, Austin, TX (US); Victor James Genty, Austin, TX (US); Zhimin Zhou, Austin, TX (US)

(21) Appl. No.: 19/474,218

(22) PCT Filed: Apr. 9, 2024
(86) PCT No.: PCT/US2024/023706

§ 371 Date: Oct. 10, 2025

Related U.S. Application Data
(60) Provisional application No. 63/459,076, filed on Apr. 13, 2023.

(51) Int. Cl. G06F 9/38; G06F 9/54

(52) U.S. Cl. CPC G06F 9/3888; G06F 9/546

(57) ABSTRACT

Provided is a system, method, and computer program product for processing inference requests to execute a machine-learning model. The system includes at least one processor programmed or configured to receive an inference request at a request handler having a first programming language capable of multithreading, communicate a first message based on the inference request from the request handler to at least one object associated with a machine-learning model, the at least one object having a second programming language different than the first programming language, determine whether to call at least one external service based on the first message and the at least one object, communicate a second message from the at least one object to an asynchronous function having the first programming language based on determining whether to call the at least one external service, and call the at least one external service via the asynchronous function while the at least one object associated with the machine-learning model executes.

### CROSS REFERENCE TO RELATED APPLICATIONS

This application is the United States national phase of International Application No. PCT/US 24/23706, filed on Apr. 9, 2024, and claims the benefit of U.S. Provisional Patent Application No. 63/459,076, filed on Apr. 13, 2023, the disclosures of which are hereby incorporated by reference in their entireties.

### BACKGROUND

### 1. Technical Field

This disclosure relates generally to machine learning and, in some non-limiting embodiments or aspects, to systems, methods, and computer program products for processing inference requests to execute a machine-learning model.

### 2. Technical Considerations

Existing machine-learning and artificial intelligence platforms that provide a real-time model inference service experience latency and inefficiently use computing resources due to restrictions with software interpreters. In existing platforms, on-boarding a new model is complex, resource-intensive, and time consuming. Moreover, restrictions on executing asynchronous processes with multithreading result in latency.

### SUMMARY

According to non-limiting embodiments or aspects, provided is a system comprising at least one processor programmed or configured to: receive an inference request at a request handler having a first programming language capable of multithreading; communicate a first message based on the inference request from the request handler to at least one object associated with a machine-learning model, the at least one object having a second programming language different than the first programming language; determine whether to call at least one external service based on the first message and the at least one object; communicate a second message from the at least one object to an asynchronous function having the first programming language based on determining whether to call the at least one external service; call the at least one external service via the asynchronous function while the at least one object associated with the machine-learning model executes; communicate a third message based on calling the at least one external service from the asynchronous function to the at least one object associated with the machine-learning model; determine an inference based on the third message and the at least one object associated with the machine-learning model; and communicate a fourth message from the at least one object to the request handler based on the inference.

In non-limiting embodiments or aspects, the at least one processor comprises at least one first processor and at least one second processor, the least one first processor executes machine-learning tasks programmed in the second programming language, and the least one second processor executes tasks programmed in the first programming language. In non-limiting embodiments or aspects, the at least one processor is further programmed or configured to: communicate a message from the at least one object to a synchronous function having the first programming language. In non-limiting embodiments or aspects, the machine-learning model comprises a risk scoring model, and the at least one processor is further programmed or configured to: generate a score based on an output of the at least one object. In non-limiting embodiments or aspects, the multithreading capability of the first programming language enables asynchronous functions to reduce latency, and the second programming language does not enable asynchronous functions without increased latency. In non-limiting embodiments or aspects, the second programming language is processed by an interpreter comprising a lock configured to allow only one thread to control the interpreter at a time.

According to non-limiting embodiments or aspects, provided is a computer-implemented method, comprising: receiving, with at least one processor, an inference request at a request handler having a first programming language capable of multithreading; communicating, with at least one processor, a first message based on the inference request from the request handler to at least one object associated with a machine-learning model, the at least one object having a second programming language different than the first programming language; determining, with at least one processor, whether to call at least one external service based on the first message and the at least one object; communicating, with at least one processor, a second message from the at least one object to an asynchronous function having the first programming language based on determining whether to call the at least one external service; calling, with at least one processor, the at least one external service via the asynchronous function while the at least one object associated with the machine-learning model executes; communicating, with at least one processor, a third message based on calling the at least one external service from the asynchronous function to the at least one object associated with the machine-learning model; determining, with at least one processor, an inference based on the third message and the at least one object associated with the machine-learning model; and communicating, with at least one processor, a fourth message from the at least one object to the request handler based on the inference.

In non-limiting embodiments or aspects, a first processor executes machine-learning tasks programmed in the second programming language, and the request handler executes tasks programmed in the first programming language. In non-limiting embodiments or aspects, the method further comprises: communicating a message from the at least one object to a synchronous function having the first programming language. In non-limiting embodiments or aspects, the machine-learning model comprises a risk scoring model, further comprising: generating a score based on an output of the at least one object. In non-limiting embodiments or aspects, the multithreading capability of the first programming language enables asynchronous functions to reduce latency, and the second programming language does not enable asynchronous functions without increased latency. In non-limiting embodiments or aspects, the second programming language is processed by an interpreter comprising a lock configured to allow only one thread to control the interpreter at a time.

According to non-limiting embodiments or aspects, provided is a computer program product comprising at least one non-transitory computer-readable medium including program instructions that, when executed by at least one processor, causes the at least one processor to: receive an inference request at a request handler having a first programming language capable of multithreading; communicate a first message based on the inference request from the request handler to at least one object associated with a machine-learning model, the at least one object having a second programming language different than the first programming language; determine whether to call at least one external service based on the first message and the at least one object; communicate a second message from the at least one object to an asynchronous function having the first programming language based on determining whether to call the at least one external service; call the at least one external service via the asynchronous function while the at least one object associated with the machine-learning model executes; communicate a third message based on calling the at least one external service from the asynchronous function to the at least one object associated with the machine-learning model; determine an inference based on the third message and the at least one object associated with the machine-learning model; and communicate a fourth message from the at least one object to the request handler based on the inference.

In non-limiting embodiments or aspects, the at least one processor comprises at least one first processor and at least one second processor, the least one first processor executes machine-learning tasks programmed in the second programming language, and the least one second processor executes tasks programmed in the first programming language. In non-limiting embodiments or aspects, the program instructions further cause the at least one processor to: communicate a message from the at least one object to a synchronous function having the first programming language. In non-limiting embodiments or aspects, the machine-learning model comprises a risk scoring model, and the program instructions further cause the at least one processor to: generate a score based on an output of the at least one object. In non-limiting embodiments or aspects, the multithreading capability of the first programming language enables asynchronous functions to reduce latency, and the second programming language does not enable asynchronous functions without increased latency. In non-limiting embodiments or aspects, the second programming language is processed by an interpreter comprising a lock configured to allow only one thread to control the interpreter at a time.

Other non-limiting embodiments or aspects will be set forth in the following numbered clauses:

Clause 1: A system comprising at least one processor programmed or configured to: receive an inference request at a request handler having a first programming language capable of multithreading; communicate a first message based on the inference request from the request handler to at least one object associated with a machine-learning model, the at least one object having a second programming language different than the first programming language; determine whether to call at least one external service based on the first message and the at least one object; communicate a second message from the at least one object to an asynchronous function having the first programming language based on determining whether to call the at least one external service; call the at least one external service via the asynchronous function while the at least one object associated with the machine-learning model executes; communicate a third message based on calling the at least one external service from the asynchronous function to the at least one object associated with the machine-learning model; determine an inference based on the third message and the at least one object associated with the machine-learning model; and communicate a fourth message from the at least one object to the request handler based on the inference.

Clause 2: The system of clause 1, wherein the at least one processor comprises at least one first processor and at least one second processor, wherein the least one first processor executes machine-learning tasks programmed in the second programming language, and wherein the least one second processor executes tasks programmed in the first programming language.

Clause 3: The system of clause 1 or 2, wherein the at least one processor is further programmed or configured to: communicate a message from the at least one object to a synchronous function having the first programming language.

Clause 4: The system of any of clauses 1-3, wherein the machine-learning model comprises a risk scoring model, and wherein the at least one processor is further programmed or configured to: generate a score based on an output of the at least one object.

Clause 5: The system of any of clauses 1-4, wherein the multithreading capability of the first programming language enables asynchronous functions to reduce latency, and wherein the second programming language does not enable asynchronous functions without increased latency.

Clause 6: The system of any of clauses 1-5, wherein the second programming language is processed by an interpreter comprising a lock configured to allow only one thread to control the interpreter at a time.

Clause 7: A computer-implemented method, comprising: receiving, with at least one processor, an inference request at a request handler having a first programming language capable of multithreading; communicating, with at least one processor, a first message based on the inference request from the request handler to at least one object associated with a machine-learning model, the at least one object having a second programming language different than the first programming language; determining, with at least one processor, whether to call at least one external service based on the first message and the at least one object; communicating, with at least one processor, a second message from the at least one object to an asynchronous function having the first programming language based on determining whether to call the at least one external service; calling, with at least one processor, the at least one external service via the asynchronous function while the at least one object associated with the machine-learning model executes; communicating, with at least one processor, a third message based on calling the at least one external service from the asynchronous function to the at least one object associated with the machine-learning model; determining, with at least one processor, an inference based on the third message and the at least one object associated with the machine-learning model; and communicating, with at least one processor, a fourth message from the at least one object to the request handler based on the inference.

Clause 8: The computer-implemented method of clause 7, wherein a first processor executes machine-learning tasks programmed in the second programming language, and wherein the request handler executes tasks programmed in the first programming language.

Clause 9: The computer-implemented method of clause 7 or 8, further comprising: communicating a message from the at least one object to a synchronous function having the first programming language.

Clause 10: The computer-implemented method of any of clauses 7-9, wherein the machine-learning model comprises a risk scoring model, further comprising: generating a score based on an output of the at least one object.

Clause 11: The computer-implemented method of any of clauses 7-10, wherein the multithreading capability of the first programming language enables asynchronous functions to reduce latency, and wherein the second programming language does not enable asynchronous functions without increased latency.

Clause 12: The computer-implemented method of any of clauses 7-11, wherein the second programming language is processed by an interpreter comprising a lock configured to allow only one thread to control the interpreter at a time.

Clause 13: A computer program product comprising at least one non-transitory computer-readable medium including program instructions that, when executed by at least one processor, causes the at least one processor to: receive an inference request at a request handler having a first programming language capable of multithreading; communicate a first message based on the inference request from the request handler to at least one object associated with a machine-learning model, the at least one object having a second programming language different than the first programming language; determine whether to call at least one external service based on the first message and the at least one object; communicate a second message from the at least one object to an asynchronous function having the first programming language based on determining whether to call the at least one external service; call the at least one external service via the asynchronous function while the at least one object associated with the machine-learning model executes; communicate a third message based on calling the at least one external service from the asynchronous function to the at least one object associated with the machine-learning model; determine an inference based on the third message and the at least one object associated with the machine-learning model; and communicate a fourth message from the at least one object to the request handler based on the inference.

Clause 14: The computer program product of clause 13, wherein the at least one processor comprises at least one first processor and at least one second processor, wherein the least one first processor executes machine-learning tasks programmed in the second programming language, and wherein the least one second processor executes tasks programmed in the first programming language.

Clause 15: The computer program product of clause 13 or 14, wherein the program instructions further cause the at least one processor to: communicate a message from the at least one object to a synchronous function having the first programming language.

Clause 16: The computer program product of any of clauses 13-15, wherein the machine-learning model comprises a risk scoring model, and wherein the program instructions further cause the at least one processor to: generate a score based on an output of the at least one object.

Clause 17: The computer program product of any of clauses 13-16, wherein the multithreading capability of the first programming language enables asynchronous functions to reduce latency, and wherein the second programming language does not enable asynchronous functions without increased latency.

Clause 18: The computer program product of any of clauses 13-17, wherein the second programming language is processed by an interpreter comprising a lock configured to allow only one thread to control the interpreter at a time.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures and drawings, in which:

FIG. 1 is a schematic diagram of a system for processing inference requests to execute a machine-learning model according to some non-limiting embodiments or aspects;

FIG. 2 is another schematic diagram of a system for processing inference requests to execute a machine-learning model according to some non-limiting embodiments or aspects;

FIGS. 3A and 3B are charts of performance results of a real-time inference engine according to some non-limiting embodiments or aspects;

FIG. 4 is a schematic diagram of example components of one or more devices according to some non-limiting embodiments or aspects; and

FIG. 5 is a schematic diagram of an electronic payment processing network used in connection with some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

An “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for processing inference requests to execute a machine-learning model that improves upon existing model inference engines. Through a new inference engine architecture that separately executes asynchronous processing tasks, non-limiting embodiments described herein improve latency associated with inference engines, reduce the computational resources needed to execute a machine-learning model, and provide real-time results (e.g., results returned prior to a process, such as a payment transaction, being completed) to enable actions to be performed. For example, some non-limiting embodiments process transaction data to determine a risk score from a machine-learning model, allowing for real-time decisions to be made based on the risk score during a transaction flow such that the decisions are made prior to completing the transaction, authorizing the transaction, and/or the like.

Existing approaches to executing a model in real-time involves a complex stack architecture, including a gateway, an orchestrator, a scoring service, and transformation service (e.g., PyTransformer). Existing approaches use a language such as GoLang® to implement both the orchestration of tasks and the execution of tasks. However, such solutions experience latency and need particular configuration files. To on-board a new model, configurations are created for at least four services, and each service may use a different parser for its respective configuration. For example, some configurations may be in consul key value and others in plain file. Including multiple calls (e.g., gRPC calls or the like) in one inference request also results in latency, such as the gateway calling the orchestrator service, the orchestrator service calling the scoring service, and the scoring service calling a transformer for a model, as examples. Each call and return message need to go through the stack for serialization and/or de-serialization. This adds pressure and demand for computational resources and results in latency. Moreover, each additional hop between services creates additional latency.

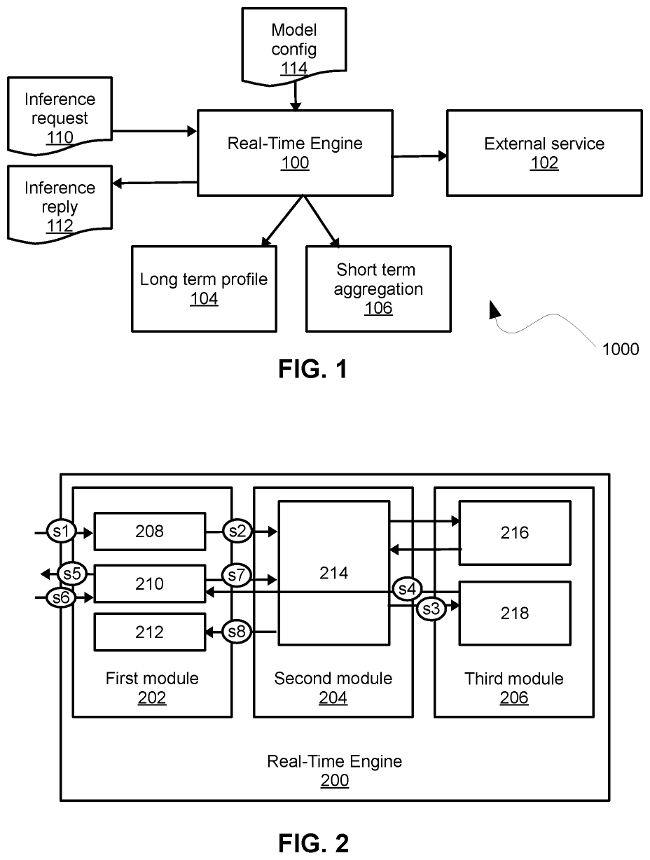

Referring to FIG. 1, shown is a system 1000 for processing inference requests to execute a machine-learning model according to non-limiting embodiments or aspects. A real-time inference engine 100 may include one or more computing devices and/or software applications executing on one or more computing devices. The real-time inference engine 100 may be configured in some non-limiting embodiments to execute a machine-learning model that returns data for use in real-time decision making (e.g., making a decision during another process or flow, before another process or flow is completed, and/or the like). As used herein, the term “real-time” refers to performance of a task or tasks during another process or before another process is completed. As an example, a real-time inference may be an inference that is obtained from a model before a payment transaction is authorized, completed, and/or the like. For example, during a payment transaction, a risk score may be determined based on transaction data, such as account information, bank information, account holder profile, and/or the like, and used to authorize or decline a transaction. Some non-limiting embodiments may be used for Stand-In Processing (STIP), in which a financial institution (such as an issuer system associated with an issuer) is unavailable to authorize a transaction and the transaction processing system acts as an authorizer instead, applying a risk model to assess the risk (e.g., fraud and/or the like).

With continued reference to FIG. 1, the real-time inference engine 100 may receive an inference request 110 including data configured to cause the real-time inference engine 100 to execute a machine-learning model to generate an output, such as a score and/or classification, based on input data included in the inference request 110. The inference request 110 may be communicated through an API or other like interface. In non-limiting embodiments, the inference request 110 may be a Remote Procedure Call (RPC) request including a feature map related to a model. The real-time inference engine 100 may be in communication with a short-term aggregation service 106, which may include one or more computing devices and/or software applications configured to generate features (e.g., feature vectors) and/or inputs for the machine-learning model for time-series analysis, as an example. The real-time inference engine 100 may be in communication with a long-term profile service 104, which may include stored data used to generate features and/or inputs for the machine-learning model to reflect historical data. As an example, in the context of a payment network, a long term profile service 104 may return a transaction history for an account and/or account holder for a month, a year, multiple years, and/or the like.

Still referring to FIG. 1, the real-time inference engine 100 may be in communication with one or more external services 102 (e.g., one or more server computers located off-premises and/or hosted by a different entity than the real-time inference engine). For example, an external service 102 may include a machine-learning engine that executes outside of the real-time inference engine 100. In some non-limiting embodiments, the external services 102 may include a TensorFlow® service and/or another platform for executing models or portions thereof under the TensorFlow® framework. In some non-limiting embodiments, the short-term aggregation service 106 and long-term profile service 104 may be external services. In non-limiting embodiments, the real-time inference engine 100 is not used to process computationally heavy tasks, instead utilizing external services 102 for such tasks and engaging in task orchestration and minor data processing tasks.

In non-limiting embodiments, the real-time inference engine 100 may output an inference reply 112, which may include one or more messages including an output of the real-time inference engine 100 based on the inference request 110. The inference reply 112 may include, for example, one or more scores, predictions, and/or other attributes determined by executing the model based on the inference request 110 input. In some non-limiting embodiments, the real-time inference engine 100 may modify (e.g., add to, alter, edit, delete from, and/or the like) the output of the model to generate the inference reply 112.

In non-limiting embodiments, and with continued reference to FIG. 1, the real-time engine may receive a model configuration file 114 to configure itself based on a new or existing model. In non-limiting embodiments, the model configuration file 114 may include Javascript Object Notation (JSON) or other structured data with configuration parameters, including but not limited to input format, output format, API commands, and/or the like. In non-limiting embodiments, the model configuration file 114 may be part of the inference request 110 or may be separate. Using a model configuration file 114 may incrementally add more configuration data in a backwards and forwards compatible manner. In non-limiting embodiments, a model configuration file 114 may be used to on-board a new machine-learning model into a testing or production environment without requiring translation or any other complex alterations to the model or programming code for executing the model.

Referring to FIG. 2, shown is a real-time inference engine 200 for processing inference requests to execute a machine-learning model according to non-limiting embodiments or aspects. The real-time inference engine 200 includes a first module 202 configured to process events (e.g., such as an event loop), including to asynchronously process inference requests, calls to external services, and/or the like, based on a first programming language (e.g., based on program instructions written in a first programming language). The first module may include, as an example, one or more software applications and/or software functions executed by one or more computing devices. As an example, the first programming language may be configured to synchronously execute tasks along with other modules (e.g., the second module 204) and/or asynchronously execute tasks in a multithreaded manner. In non-limiting embodiments, the first programming language may include Rust, C++, or Go, although it will be appreciated that various other languages may be used. The first module 202 may include inference request handlers 208, 212 (e.g., RPC request handlers) and a call module 210. In non-limiting embodiments, the request handlers 208, 212 may include software applications and/or software functions. The modules 202, 204, 206 may be physically and/or logically separated in non-limiting embodiments.

With continued reference to FIG. 2, the real-time inference engine 200 includes a second module 204 configured to interpret a second programming language. The second module may include, as an example, one or more software applications and/or software functions executed by one or more computing devices. The second module 204 may be executed by the same or separate computing device that executes the first module 202. As an example, the second programming language may be Python® and the second module 204 may include a Python® interpreter engine and a software object 214 including logic (e.g., program code) in Python® (or another programming language different than a first programming language used by the first module 202, such as Lua® or the like) for executing tasks associated with a machine-learning model. The object 214 may include the machine-learning model and/or logic associated therewith. In non-limiting embodiments, an interpreter of the second module 204 may include an interpreter lock that allows only one thread to control the interpreter at a time. In non-limiting embodiments, the use of a second programming language like Python® allows for separate preexisting programs and functions to be used without needing to be translated into another language (e.g., such as GoLang®).

With continued reference to FIG. 2, the real-time inference engine 200 includes a third module 206 configured for synchronous processing (e.g., to process tasks in synchronization with tasks executed by the second module 204) in the first programming language. The third module may include, as an example, one or more software applications and/or software functions executed by one or more computing devices. The third module 206 and the first module 202 may be the same module in some examples. The third module 206 may be executed by the same or separate computing device that executes the first module 202 and/or second module 204. In non-limiting embodiments, the third module 206 may include a synchronous processing module 216 and an asynchronous processing module 218. The synchronous processing module 216 may include one or more software applications configured to execute computationally-intensive tasks in a first programming language (e.g., different than the second programming language of the interpreter of the second module 204) in sync with tasks executed by the second module 204 (e.g., substantially synchronized with respect to sequence of execution). The asynchronous processing module 218 may generate and communicate requests to an external service (e.g., such as external service 102 shown in FIG. 1) to perform one or more asynchronous functions (e.g., not substantially synchronized with respect to sequence of execution of tasks performed by the second module 204). In some non-limiting embodiments, the asynchronous processing module 218 may communicate with the call module 210 of the first module 202 to communicate a request (e.g., such as an API call or the like) to an external service. In some examples, the asynchronous processing module 218 may be the same module as the call module 210.

FIG. 2 shows steps s1-s7 for the purpose of illustrating a method of processing inference requests to execute a machine-learning model according to non-limiting embodiments or aspects. It will be appreciated that different, additional, fewer, and/or a different order of steps may be employed in various embodiments. In non-limiting embodiments or aspects, each step and/or one or more steps in FIG. 2 may be performed automatically in response to the performance and/or completion of a previous step.

Referring to FIGS. 1 and 2, an inference request 110 may be received by a request handler 208 of a real-time inference engine 100, 200 (e.g., step s1 shown in FIG. 2). The request handler 208 may interpret the inference request 110 using a first programming language capable of multithreading to execute asynchronous tasks. At step s2 the request handler 208 may then communicate a first message based on the inference request 110 to the model object 214 of the second module 204. The model object 214 may include logic associated with a machine-learning model and a second programming language. As part of executing the logic of the model object 214, the second module 204 may determine whether to call at least one external service 102 based on the logic and the data in the inference request 110. For example, if one or more asynchronous functions are called for in the logic, the second module 204 may determine to call at least one external service 102.

With continued reference to FIGS. 1 and 2, in response to determining to call at least one external service, a second message may be generated by and communicated from the model object 214 to request performance of one or more asynchronous functions. For example, a message may be communicated to the asynchronous processing module 218 at step s3. The asynchronous processing module 218 of the third module 206 may generate a call (e.g., an API call, a RPC, and/or the like) to an external service 102 while (e.g., at the same time as) the model object 214 associated with the machine-learning module is executed by the second module 204. The asynchronous processing module 218 may communicate with the call module 210 at step s4, which communicates the call to the external service 102 at step s5. The call module 210 waits for the response from the external service at step s6.

Still referring to FIGS. 1 and 2, at step s7 the call module 210 may communicate the response from the external service 102 to the model object 214. The output of the second module 204 may be communicated to a request handler 212 of the first module 202 at step s8. For example, in response to receiving the result of an asynchronous processing task, the model object 214 may determine an inference based on the output and the machine-learning model. In some examples, the model object 214 may generate and communicate a fourth message to the request handler 212 of the first module based on the inference. In some examples, the model object 214 may perform other processing tasks and/or call the third module 206 and/or external service 102 based on the third message and/or other messages and outputs received. It will be appreciated that the communications and messages discussed herein with regard to FIGS. 1 and 2 are for example purposes only and that different flows, sequences, and arrangements may be utilized in non-limiting embodiments.

In non-limiting embodiments, one or more first processors may be used to execute logic in the first programming language and one or more second processors may be used to execute logic in the second programming language. For example, with reference to the non-limiting embodiment shown in FIG. 2, a first CPU or GPU (or group thereof) may execute functions with the first module 202 and third module 206, and a second CPU or GPU (or group thereof) may execute functions with the second module 204. As another example, different CPUs or GPUs (or groups thereof) may execute functions separately for each of the first module, second module 204, and third module 206.

With reference to FIGS. 1 and 2, the system 1000 may be implemented in a real-time flow, such as during processing a payment transaction, to provide information regarding an action or to make a decision. For example, the model object 214 may include a fraud and/or risk model configured to generate one or more scores based on account data and/or transaction data. In some non-limiting embodiments, the system 1000 may be used for STIP transactions in which a financial institution (such as an issuer system associated with an issuer) is unavailable to authorize a transaction and the transaction processing system acts as an authorizer instead, applying a fraud and/or risk model to determine a score to compare to a threshold and, based on the comparison, determine to approve or deny the transaction. Such implementations for STIP transactions may avoid a cache effect that creates complexities and computational inefficiencies from caching scores and/or other data for use during a STIP transaction.

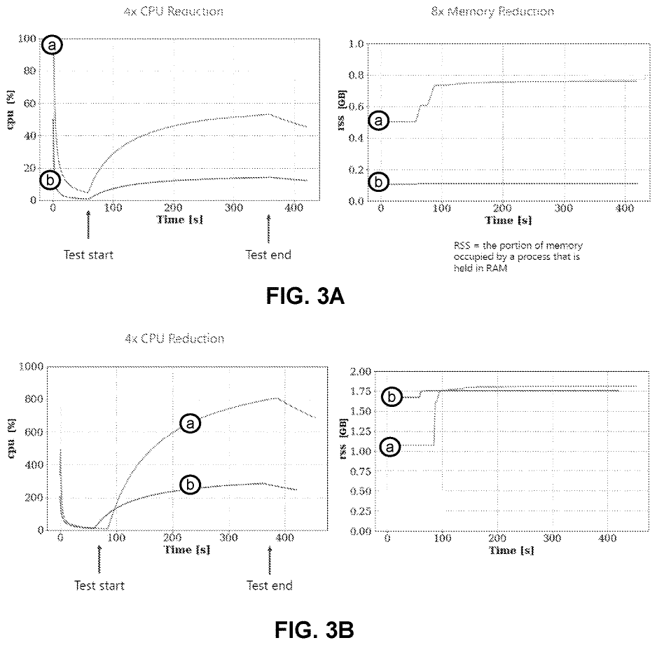

Referring now to FIGS. 3A and 3B, shown are charts of performance results of a real-time inference engine according to non-limiting embodiments (labeled “b”) compared to an existing system for executing a machine-learning model (labeled “a”). FIGS. 3A and 3B show a significant reduction in processing resources (left charts). FIG. 3A shows a significant reduction in memory usage (measured by Resident Set Size (RSS), including the portion of memory occupied by a process held in Random Access Memory (RAM) at a given time) in a non-limiting embodiment. In FIG. 3A, a configuration with two CPUs was used for both “a” (existing system with orchestration service, gateway service, scoring service, and transformation service) and “b” (non-limiting embodiment of a real-time inference engine). In FIG. 3B, a configuration with 32 CPUs was used for both “a” and “b” results. It will be appreciated that improvement metrics may change with different implementations of the non-limiting embodiments described herein.

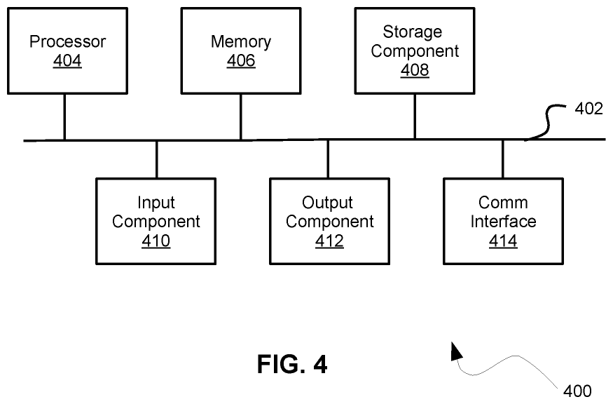

Referring now to FIG. 4, shown is a diagram of example components of a device 400 according to non-limiting embodiments or aspects. Device 400 may correspond to at least one of the computing devices shown and described in connection with FIGS. 1 and 2. In non-limiting embodiments or aspects, such systems or devices may include at least one device 400 and/or at least one component of device 400. The number and arrangement of components shown in FIG. 4 are provided as an example. In non-limiting embodiments or aspects, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

As shown in FIG. 4, device 400 may include bus 402, processor 404, memory 406, storage component 408, input component 410, output component 412, and communication interface 414. Bus 402 may include a component that permits communication among the components of device 400. In non-limiting embodiments or aspects, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

With continued reference to FIG. 4, storage component 408 may store information and/or software related to the operation and use of device 400. For example, storage component 408 may include a hard disk (e.g., a magnetic disk, an optical disk, a magneto-optic disk, a solid state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally, or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

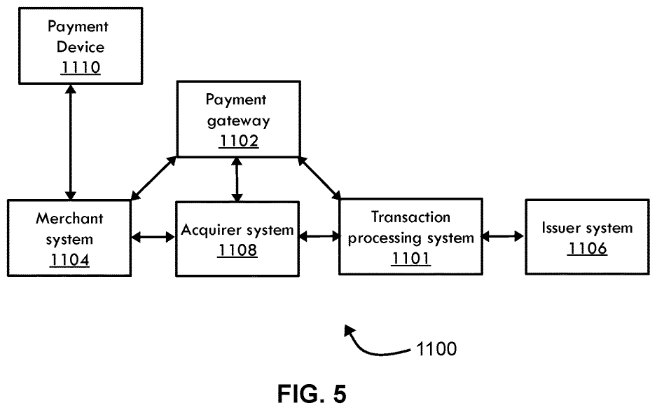

FIG. 5 shows an electronic payment processing network 1100 according to non-limiting embodiments or aspects. The payment processing network may be used in conjunction with the systems and methods described herein. For example, the transaction processing system 1101, merchant system 1104, and/or issuer system 1106 may process a payment transaction using the model inferences described herein. As another example, the transaction processing system 1101 may use non-limiting embodiments for STIP payment processing as described herein. It will be appreciated that the particular arrangement of electronic payment processing network 1100 shown is for example purposes only, and that various arrangements are possible. Transaction processing system 1101 (e.g., a transaction handler) is shown to be in communication with one or more issuer systems (e.g., such as issuer system 1106) and one or more acquirer systems (e.g., such as acquirer system 1108). Although only a single issuer system 1106 and single acquirer system 1108 are shown, it will be appreciated that transaction processing system 1101 may be in communication with a plurality of issuer systems and/or acquirer systems. In some embodiments, transaction processing system 1101 may also operate as an issuer system such that both transaction processing system 1101 and issuer system 1106 are a single system and/or controlled by a single entity.

In some non-limiting embodiments or aspects, transaction processing system 1101 may communicate with merchant system 1104 directly through a public or private network connection. Additionally or alternatively, transaction processing system 1101 may communicate with merchant system 1104 through payment gateway 1102 and/or acquirer system 1108. In some non-limiting embodiments or aspects, an acquirer system 1108 associated with merchant system 1104 may operate as payment gateway 1102 to facilitate the communication of transaction requests from merchant system 1104 to transaction processing system 1101. Merchant system 1104 may communicate with payment gateway 1102 through a public or private network connection. For example, a merchant system 1104 that includes a physical POS device may communicate with payment gateway 1102 through a public or private network to conduct card-present transactions. As another example, a merchant system 1104 that includes a server (e.g., a web server) may communicate with payment gateway 1102 through a public or private network, such as a public Internet connection, to conduct card-not-present transactions.

In some non-limiting embodiments or aspects, transaction processing system 1101, after receiving a transaction request from merchant system 1104 that identifies an account identifier of a payor (e.g., such as an account holder) associated with an issued payment device 1110, may generate an authorization request message to be communicated to the issuer system 1106 that issued the payment device 1110 and/or account identifier. Issuer system 1106 may then approve or decline the authorization request and, based on the approval or denial, generate an authorization response message that is communicated to transaction processing system 1101. Transaction processing system 1101 may communicate an approval or denial to merchant system 1104. When issuer system 1106 approves the authorization request message, it may then clear and settle the payment transaction between the issuer system 1106 and acquirer system 1108.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

1. A system comprising at least one processor programmed or configured to:
receive an inference request at a request handler having a first programming language capable of multithreading;
communicate a first message based on the inference request from the request handler to at least one object associated with a machine-learning model, the at least one object having a second programming language different than the first programming language;
determine whether to call at least one external service based on the first message and the at least one object;
communicate a second message from the at least one object to an asynchronous function having the first programming language based on determining whether to call the at least one external service;
call the at least one external service via the asynchronous function while the at least one object associated with the machine-learning model executes;
communicate a third message based on calling the at least one external service from the asynchronous function to the at least one object associated with the machine-learning model;
determine an inference based on the third message and the at least one object associated with the machine-learning model; and
communicate a fourth message from the at least one object to the request handler based on the inference.

2. The system of claim 1, wherein the at least one processor comprises at least one first processor and at least one second processor, wherein the least one first processor executes machine-learning tasks programmed in the second programming language, and wherein the least one second processor executes tasks programmed in the first programming language.

3. The system of claim 1, wherein the at least one processor is further programmed or configured to:
communicate a message from the at least one object to a synchronous function having the first programming language.

4. The system of claim 1, wherein the machine-learning model comprises a risk scoring model, and wherein the at least one processor is further programmed or configured to:
generate a score based on an output of the at least one object.

5. The system of claim 1, wherein the multithreading capability of the first programming language enables asynchronous functions to reduce latency, and wherein the second programming language does not enable asynchronous functions without increased latency.

6. The system of claim 1, wherein the second programming language is processed by an interpreter comprising a lock configured to allow only one thread to control the interpreter at a time.

7. A computer-implemented method, comprising:
receiving, with at least one processor, an inference request at a request handler having a first programming language capable of multithreading;
communicating, with at least one processor, a first message based on the inference request from the request handler to at least one object associated with a machine-learning model, the at least one object having a second programming language different than the first programming language;
determining, with at least one processor, whether to call at least one external service based on the first message and the at least one object;
communicating, with at least one processor, a second message from the at least one object to an asynchronous function having the first programming language based on determining whether to call the at least one external service;
calling, with at least one processor, the at least one external service via the asynchronous function while the at least one object associated with the machine-learning model executes;
communicating, with at least one processor, a third message based on calling the at least one external service from the asynchronous function to the at least one object associated with the machine-learning model;
determining, with at least one processor, an inference based on the third message and the at least one object associated with the machine-learning model; and
communicating, with at least one processor, a fourth message from the at least one object to the request handler based on the inference.

8. The computer-implemented method of claim 7, wherein a first processor executes machine-learning tasks programmed in the second programming language, and wherein the request handler executes tasks programmed in the first programming language.

9. The computer-implemented method of claim 7, further comprising:
communicating a message from the at least one object to a synchronous function having the first programming language.

10. The computer-implemented method of claim 7, wherein the machine-learning model comprises a risk scoring model, further comprising:
generating a score based on an output of the at least one object.

11. The computer-implemented method of claim 7, wherein the multithreading capability of the first programming language enables asynchronous functions to reduce latency, and wherein the second programming language does not enable asynchronous functions without increased latency.

12. The computer-implemented method of claim 7, wherein the second programming language is processed by an interpreter comprising a lock configured to allow only one thread to control the interpreter at a time.

13. A computer program product comprising at least one non-transitory computer-readable medium including program instructions that, when executed by at least one processor, causes the at least one processor to:
receive an inference request at a request handler having a first programming language capable of multithreading;
communicate a first message based on the inference request from the request handler to at least one object associated with a machine-learning model, the at least one object having a second programming language different than the first programming language;
determine whether to call at least one external service based on the first message and the at least one object;
communicate a second message from the at least one object to an asynchronous function having the first programming language based on determining whether to call the at least one external service;
call the at least one external service via the asynchronous function while the at least one object associated with the machine-learning model executes;
communicate a third message based on calling the at least one external service from the asynchronous function to the at least one object associated with the machine-learning model;
determine an inference based on the third message and the at least one object associated with the machine-learning model; and
communicate a fourth message from the at least one object to the request handler based on the inference.

14. The computer program product of claim 13, wherein the at least one processor comprises at least one first processor and at least one second processor, wherein the least one first processor executes machine-learning tasks programmed in the second programming language, and wherein the least one second processor executes tasks programmed in the first programming language.

15. The computer program product of claim 13, wherein the program instructions further cause the at least one processor to:
communicate a message from the at least one object to a synchronous function having the first programming language.

16. The computer program product of claim 13, wherein the machine-learning model comprises a risk scoring model, and wherein the program instructions further cause the at least one processor to:
generate a score based on an output of the at least one object.

17. The computer program product of claim 13, wherein the multithreading capability of the first programming language enables asynchronous functions to reduce latency, and wherein the second programming language does not enable asynchronous functions without increased latency.

18. The computer program product of claim 13, wherein the second programming language is processed by an interpreter comprising a lock configured to allow only one thread to control the interpreter at a time.
